(19) United States
(12) Patent Application Publication
(10) Pub. No.: US 2016/0290783 A1
(43) Pub. Date: Oct. 6, 2016

(54) Swept Source Terahertz Coherence Tomography

(71) Applicant: Traycer Diagnostic Systems, Inc., Burlingame, CA (US)

(72) Inventor: Don J. Burdette, Columbus, OH (US)

(73) Assignee: Traycer Diagnostic Systems, Inc., Burlingame, CA (US)

(21) Appl. No.: 15/040,317

(22) Filed: Feb. 10, 2016

Related U.S. Application Data
(60) Provisional application No. 62/141,378, filed on Apr. 1, 2015.

(51) Int. Cl. G01B 9/02

(52) U.S. Cl. CPC G01B 9/02004; G01B 9/02091; G01B 9/02011

(57) ABSTRACT

Disclosed is a method for a phase-insensitive single-sampling point (SSP) data collection system. A rotated 90° infrared (IR) THz signal from a step-tunable IR laser is passed though the fast axis of a 90° polarizing rotator. The polarizing rotator and a second IR signal are coupled to free space through an electro-optic phase modulator (EO-PM), where the EO-PM only retards the phase of along the slow-axis. The polarization angle is rotated by 45° to form a beat frequency in each arm. The light is passed through a polarizer aligned with the slow axis of the PM fiber. Lastly, a resultant IR beat signal is fiber coupled back into the system and an erbium doped fiber amplifier (EDFA) in each arm amplifies the IR power prior to pump the THz emitter and detector.

### CROSS-REFERENCE TO RELATED APPLICATIONS

This application claims benefit of provisional application U.S. Ser. No. 62/141,378 filed Apr. 1, 2015.

### STATEMENT REGARDING FEDERALLY SPONSORED RESEARCH

Not applicable.

### BACKGROUND

The present invention is directed to Swept Source Terahertz Coherence Tomography (SS-TCT) and more particularly to an improved such device and method.

Swept Source Terahertz Coherence Tomography (SS-TCT) is a photomixer based, continuous wave (CW) spectroscopic measurement method that utilizes the single-sampling point (SSP) technique, [Gôbel, T., D. Schoenherr, C. Sydlo, M. Feiginov, P. Meissner, and H. L. Hartnagel, “Single-sampling point coherent detection in continuous-wave photomixing terahertz systems,” Electronic Letters, Vol. 45, No. 1, January (2009)] driven by a fixed frequency telecom laser and a rapid-scanning, frequency-step tunable telecom laser. The SS-TCT architecture enables spectral collection rates (on the order of 100-1000 Hz) that are necessary for on-the-assembly-line, non-destructive evaluation measurements.

### BRIEF SUMMARY

Disclosed is a method for a phase-insensitive single-sampling point (SSP) data collection system. A rotated 90° infrared (IR) THz signal from a step-tunable IR laser is passed though the fast axis of a 90° polarizing rotator. The polarizing rotator and a second IR signal are coupled to free space through an electro-optic phase modulator (EO-PM), where the EO-PM only retards the phase of along the slow-axis. The polarization angle is rotated by 45° to form a beat frequency in each arm. The light is passed through a polarizer aligned with the slow axis of the PM fiber. Lastly, a resultant IR beat signal is fiber coupled back into the system and an erbium doped fiber amplifier (EDFA) in each arm amplifies the IR power prior to pump the THz emitter and detector.

### BRIEF DESCRIPTION OF THE DRAWINGS

For a fuller understanding of the nature and advantages of the present method and process, reference should be had to the following detailed description taken in connection with the accompanying drawings, in which:

FIG. 1 is an example block diagram of a conventional CW THz spectrometer.

FIG. 2 shows raw THz data collected using the conventional CW THz spectrometer shown in FIG. 1.

FIG. 3 is a CW THz Spectrometer set-up for use with the Single Sampling Point (SSP) data collection method. A cross geometry configuration of fiber beam splitter/combiners is used in conjunction with an electro-optic phase modulator (EO-PM) to modulate the phase difference between the THz wave and the IR beat frequency at the Rx photodiode. [Image from: Image from: Gôbel, T., D. Schoenherr, C. Sydlo, M. Feiginov, P. Meissner, and H. L. Hartnagel, “Single-sampling point coherent detection in continuous-wave photomixing terahertz systems,” Electronic Letters, Vol. 45, No. 1, January (2009)].

FIG. 4 is the expected waveform of the modulated voltage applied to the EO-PM and the resultant signal measured by the THz receiver. The upper waveform shows the voltage applied across the EO-PM. The bottom plot shows that a sinusoidal waveform is recorded by the THz detector when the EO-PM is modulated with a ramp filter between ±Vλ/2. [Image from T Gôbel, D. Schoenherr, C. Sydlo, M. Feiginov, P. Meissner, and H. L. Harnagel, “Single-sampling-point coherent detection in continuous-wave photomixing terahertz systems,” Electronic Letters, Vol 45, No. 1.].

FIG. 5 is a comparison of a THz spectrum collected using the SSP technique compared to other modulation schemes. The inset shows that the amplitude measured by the lock-in amplifier is used to build the THz spectrum directly at every sampled THz frequency without tracing out a fringe pattern to located extrema (as is the case for the conventional CW THz spectrometer shown in FIG. 1). The above image is a modification of that published in T Gôbel, D. Schoenherr, C. Sydlo, M. Feiginov, P. Meissner, and H. L. Harnagel, “Single-sampling-point coherent detection in continuous-wave photomixing terahertz systems,” Electronic Letters, Vol 45, No. 1.

FIG. 6 is an SSP experimental set-up that removes vibration induced phase noise, based on the work published in Stanze, D; Gobel, T; Sartorius, B; Schell, M, “Inline electro-optical phase control for CW terahertz system,” IEEE, Jan. 2,2011.

FIG. 7 is a block diagram of the disclosed industrial ready CW THz spectral system. The introduction of a fast, step tunable IR laser (gray component) into the phase-noise resistant SSP set-up allows for spectral collection rates on the order of 100-1000 Hz.

FIG. 8 summarizes the relationship between spectral acquisition rate, IR frequency dwell time, lock-in integration time, and lock-in modulation rate; where the left graphic shows laser-tuning mode and the right table shows settings for various spectral collection rates.

The drawings will be described in greater detail below.

### DETAILED DESCRIPTION

Conventional THz CW spectrometers are composed of two sub-systems: one in the infrared (IR) regime and the other in the THz regime. The IR-subsystem is used as the pump source for the generation of THz light. It is responsible for the frequency tuning and overall stability of the THz signal. The THz portion of the system is composed of a homodyne linked emitter/detector pair and a free-space optical system that guides the THz light through the sample under study. Such systems use a photomixer as the THz emitter that converts the IR radiation into THz light, while the detector is a photodiode that converts THz radiation into an electrical current.

FIG. 1 shows a block diagram of a conventional CW THz spectrometer system. The output of two fiber-coupled frequency off-set, CW IR telecom lasers (with associated frequency and power controls) are combined to form a beat frequency in the THz regime. An erbium doped fiber amplifier (EDFA) is often used to boost the IR power to maximize the dynamic range of the emitter/detector pair. THz spectra are collected by tuning the wavelength difference between the IR lasers. A lock-in amplification circuit is used to record the small currents generated by the THz detector. The lock-in detection technique requires that the THz signal be modulated at a narrow-band frequency. Typically, this is achieved either by turning on and off the THz emitter by modulating the bias voltage (A. Roggenbuck, H. Schmitx, A. Deninger, I. Cámara Moyorga, J. Hemberger, R. Güsten and M. Gruninger, “Coherent broadband continuous-wave terahertz spectroscopy on solid-state samples,” New Journal of Physics 12 (2010) 043017, from which FIG. 1 is taken).

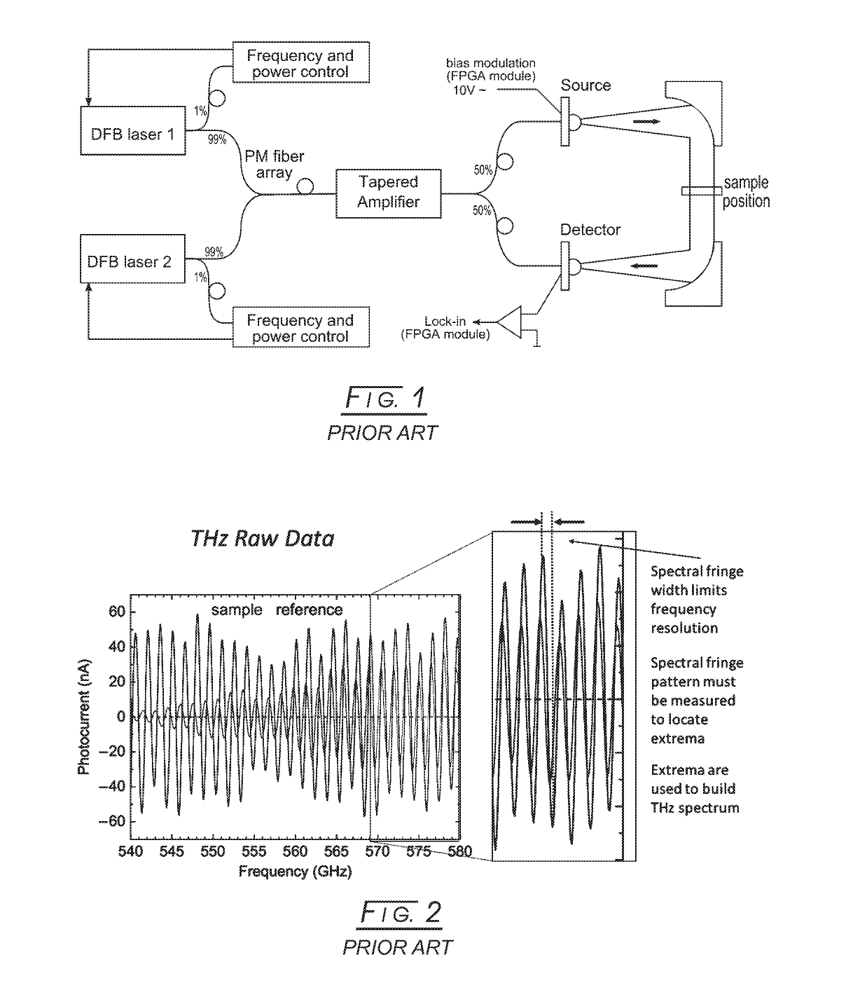

FIG. 2 shows raw THz data collected using the conventional CW THz spectrometer shown in FIG. 1. The THz spectrum is built by identifying the extrema of the spectral fringe pattern. This image is a modification of that published in A. Roggenbuck, H. Schmitz, A. Deninger, I Cámara Mayorga, J. Jemberger, R Güsten, and M Grüninger, “Coherent broadband continuouse-wave terahertz spectroscopy on solid-state samples,” New Journal of Physics, 12 (2010) 043017. The observed spectral fringe pattern arises due to the phase sensitivity of the homodyne measurement. A THz spectrum is obtained by locating the frequency and intensity of the extrema of the fringe pattern. The frequency resolution of this data is proportional to the width of the spectral fringes, while the spectral acquisition rate is dependent on the number of off-extrema data points that must be collected to accurately determine the extrema intensities and spectral locations. Modifying the optical path length difference between the emitter and detector can alter the period of the spectral fringes, offering a trade-off between spectral collection times and THz frequency resolution. For example, a tight spectral fringe period will improve the frequency resolution, but requires a denser frequency sampling that extends the spectral acquisition time. Conversely, sparse frequency steps can be collected for wider fringe periods, resulting in faster spectral acquisition times, but at the cost of degradation to the frequency resolution.

Spectral acquisition times of several seconds can be obtained with the system described above for frequency resolutions on the order of 1.0 GHz. The spectral acquisition time is ultimately limited by the minimum time it takes to tune the frequency difference between the IR lasers (˜10-60 seconds for a 0.1-1.2 THz bandwidth spectrum). Such spectral acquisition times are acceptable in a research environment, but fall far short of the 1-10 ms spectral collection times (100-1000 Hz) necessary to enable industrial applications.

It is worth noting, that the fringe pattern discussed above can be removed entirely by incorporating a delay line that alters the path length difference between the detector and emitter arms of the system. Since inserting delay lines in the THz free-space introduces aberrations in the THz optics, delay schemes in the IR sub-system are typically used. Such systems include mechanical delay lines (Stanze, D, H-G Bach, R Kunkel, D Schmidt, H Roehle, M Schlak, M Schell, B Sartorius, “Coherent CW terahertz systems employing photodiode emitters,” Proceedings IRMMW 2009, 2009) and fiber stretchers (Roggenbuck A, K Thirunavukkuarasu, H Schmitx, J Marx, A Deninger, I C Mayorga, R Güsten, J Hemberger, and Markus Grüninger, “Using a fiber stretcher as a fast phase modulator in a continuous wave terahertz spectrometer,”J. Opt. Soc. Am. B. Vol 29, No. 4/April 2012 pp 614-620). Such systems will not be discussed in further detail here since their spectral collection time is greater than the set-up shown in FIG. 1.

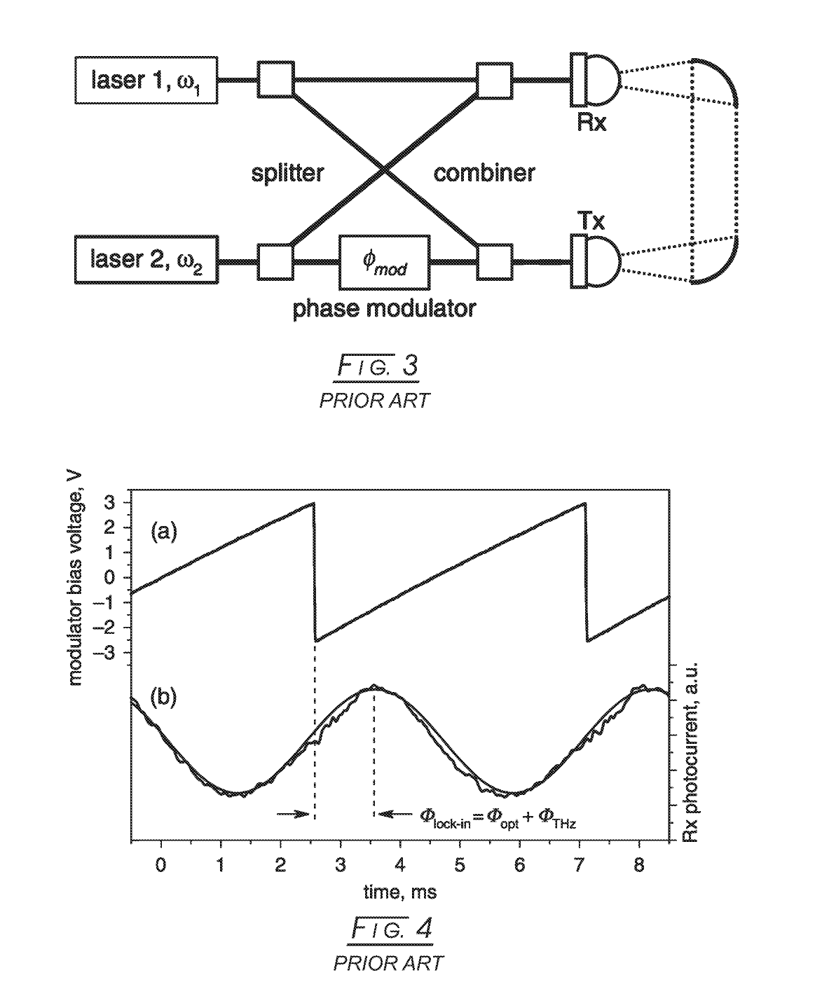

Both spectral acquisition times and frequency resolution can be improved significantly by utilizing the single-sampling-point (SSP) measurement technique. FIG. 3 is a diagram of an SSP CW THz spectrometer set-up as it was originally described in the scientific literature [Göbel, T., D. Schoenherr, C. Sydlo, M. Feiginov, P. Meissner, and H. L. Hartnagel, “Single-sampling point coherent detection in continuous-wave photomixing terahertz systems,” Electronic Letters, Vol. 45, No. 1, January (2009)]. This set-up differs from conventional CW THz spectrometers in that it incorporates an electro-optic phase modulator (EO-PM), 30, which is used to shift the phase of the IR light passing through the crystal. The degree of phase shift is directly proportional to the DC bias voltage applied across the EO-PM. Appling a ramp voltage that oscillates between ±V_{λ/2} (the half wave voltage) will trace out a full THz wavelength, which is recorded by the Rx photodiode as an oscillatory current with the same period as the ramp filter (see FIG. 4). A standard lock-in amplifier detection scheme can be used to record the magnitude and phase of the THz wave simultaneously using the ramp voltage signal as the lock-in amplifier reference frequency. This measurement scheme comes with the following advantages:
1. Simultaneous measurement of THz amplitude and phase allows the THz spectrum to be directly recorded without the need to trace out a spectral fringe pattern (see FIG. 5); thus, significantly improving data acquisition rates.
2. Frequency resolution is no longer coupled to the period of the fringe spacing, but instead by the frequency step-size or, ultimately, the laser line widths.
3. The EO-PM can be modulated at rates between 1 kHz and several GHz, offering the opportunity to collect high-dynamic range spectra rapidly.
   However, the SSP set-up (as originally proposed) suffers from vibration induced phase shifts introduced by the non-common IR fiber paths that are used to combine and split the IR light. This vibration induced phase noise can be reduced using vibration isolation techniques (such as vibration isolation optical tables); however, such techniques are not amenable to industrial environments.

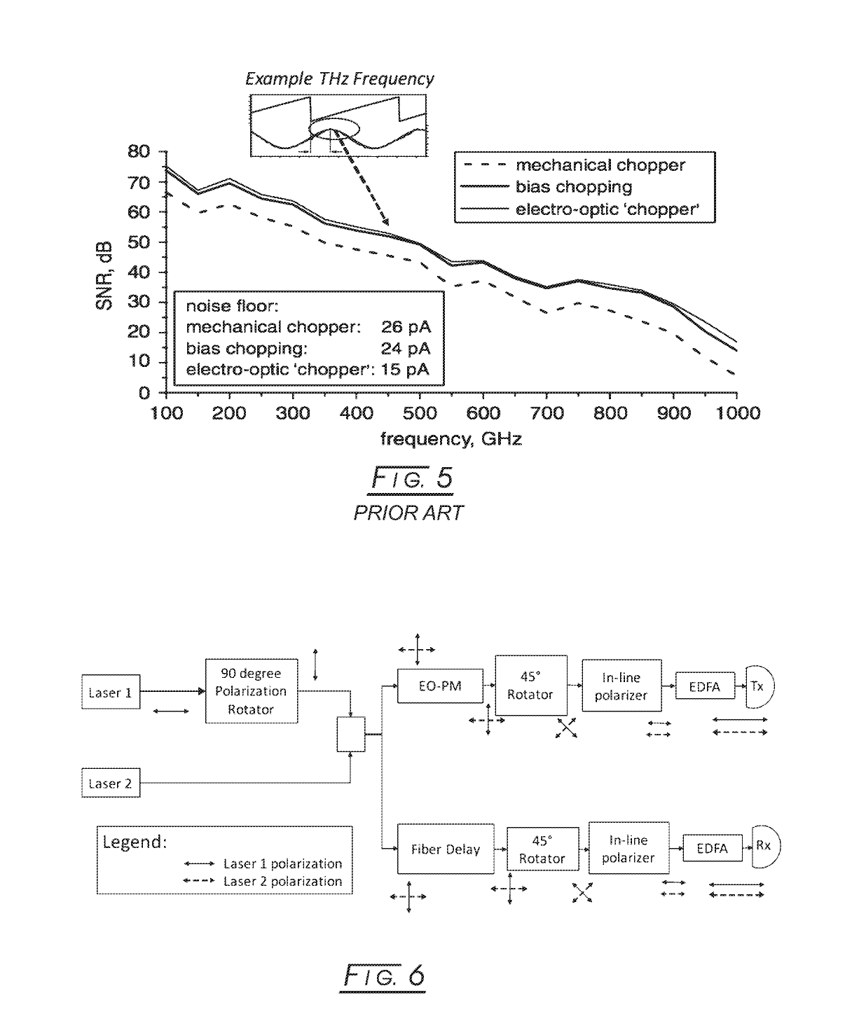

An improvement to the SSP data collection set-up that removes the vibration induced phase noise is shown in FIG. 6. The vibration induced phase noise is removed by using common elements to combine and split the IR signals. In such a set-up, the output of the IR laser is rotated by 90° and placed onto the fast axis of the polarization maintaining (PM) IR fiber. The outputs of both IR lasers are combined onto the same PM cable, one aligned along the slow axis, the other along the fast-axis. The EO-PM only retards the phase of the IR light aligned with the slow-axis, meaning that the phase difference of the IR signals can be modulated without using the cross-geometry fiber paths shown in FIG. 3, thus removing vibration noise introduced by non-common IR paths. A beat frequency is created after passing through the EO-PM by rotating the polarization of the light by 45° and passing the resultant light through a polarizer aligned with the slow-axis of the PM fiber. The resultant IR beat signal is amplified by an EDFA in each IR arm prior to pumping the THz emitter and detector. The set-up shown in FIG. 6 is nearly ready for industrial applications; however, it (like the conventional CW THz spectrometer) is limited by the spectral tuning time of the IR lasers.

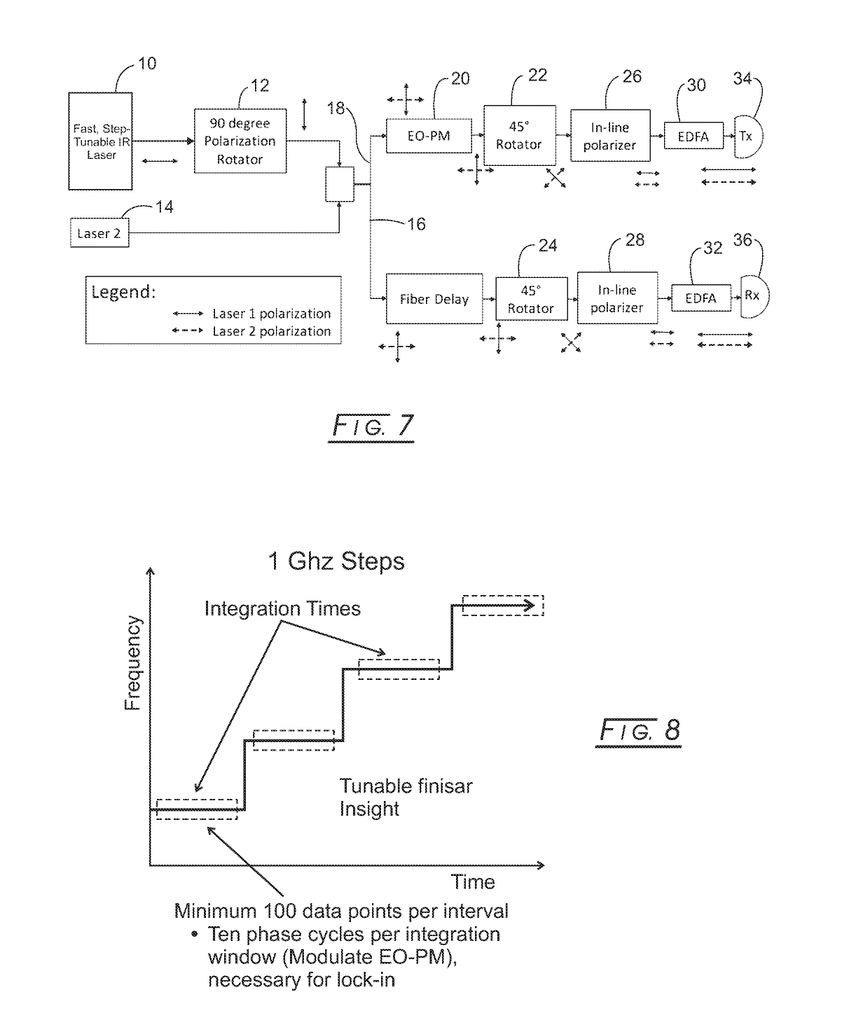

FIG. 7 is the disclosed industrial-grade THz CW spectrometer system that can be realized by incorporating a step-tunable IR laser, 10, that can rapidly scan through the THz spectrum at a rate of 100-1000 Hz into a phase-noise-insensitive SSP data collection set-up. The outputs of laser 10 and a second laser, 14, are combined onto the same PM cable, one aligned along the slow axis, 16, the other along the fast-axis, 18. The EO-PM, 20, only retards the phase of the IR light aligned with the slow-axis, meaning that the phase difference of the IR signals can be modulated without using the cross-geometry fiber paths shown in FIG. 3, thus removing vibration noise introduced by non-common IR paths. A beat frequency is created after passing through EO-PM 20 by rotating the polarization of the light by 45° in rotators, 22 and 24, and passing the resultant light through polarizers, 26 and 28, aligned with the slow-axis of the PM fiber. The resultant IR beat signal is amplified by EDFA's, 30 and 32, in each IR arm prior to pumping a THz emitter, 34, and a detector, 36.

The disclosed system is rugged enough for industrial applications, while simultaneously delivering the data acquisition rates required for industrial settings. IR laser 10 employed in this system can be discreetly tuned with frequency steps between 0.1-10 GHz over a bandwidth of 100-1200 GHz. The settling time between frequencies is on the order of 100 ns, allowing for lock-in integration times of 1-10 μs for modulation frequencies of 10-1 MHz, respectively.

FIG. 8 summarizes the relationship between spectral acquisition rate, IR frequency dwell time, lock-in integration time, and lock-in modulation rate for the system of FIG. 7, where the left graphic shows laser-tuning mode (100-1000 Hz; 100 data points minimum per interval; 10 phase cycles per integration window) and the following table shows settings for various spectral collection rates.

TABLE I

| | Laser 1 | Laser 2 | Laser 3 |
|---|---|---|---|
| | Setting | Setting | Setting |
| Refresh Rate (Hz) | 10 | 100 | 1000 |
| Integration Time (ns) | 1000 | 100 | 10 |
| DAQ Rate (Mz) | 1 | 10 | 100 |
| EO-PM Modulation Rate (MHz) | 0.1 | 1 | 10 |

While the apparatus, system, and method have been described with reference to various embodiments, those skilled in the art will understand that various changes may be made and equivalents may be substituted for elements thereof without departing from the scope and essence of the disclosure. In addition, many modifications may be made to adapt a particular situation or material in accordance with the teachings of the disclosure without departing from the essential scope thereof. Therefore, it is intended that the disclosure not be limited to the particular embodiments disclosed, but that the disclosure will include all embodiments falling within the scope of the appended claims. In this application all citations set forth herein are expressly incorporated herein by reference.

I claim:

1. Method for a phase-insensitive single-sampling point (SSP) data collection system, which comprises the steps of:
(a) passing a rotated 90° infrared (IR) THz signal from a step-tunable infrared (IR) laser though the fast axis of a 90° polarizing rotator;
(b) coupling the polarizing rotator and a second IR signal to free space through an electro-optic phase modulator (EO-PM), where the EO-PM only retards the phase of along the slow-axis;
(c) rotating the polarization angle by 45° to form a beat frequency in each arm;
(d) passing the light through a polarizer aligned with the slow axis of the PM fiber; and
(e) fiber coupling a resultant IR beat signal back into the system and an erbium doped fiber amplifier (EDFA) in each arm amplifies the IR power prior to pump the THz emitter and detector.

2. The method of claim 1, wherein the step-tunable IR laser rapidly scans through the THz spectrum at a rate of 100-1000 Hz.

3. The method of claim 1, wherein the step-tunable IR laser can be discretely tuned at frequency steps between 0.1-10 GHz over a bandwidth of 100-1200 GHz.
